(19) United States
(12) Patent Application Publication
(10) Pub. No.: US 2012/0167275 A1
(43) Pub. Date: Jul. 5, 2012

(54) PROTECTIVE HEADWEAR

(76) Inventor: Chevis Pugh, Fresno, CA (US)

(21) Appl. No.: 12/985,251

(22) Filed: Jan. 5, 2011

(51) Int. Cl. A45D 44/00; B23P 11/00

(52) U.S. Cl. 2/174; 29/428

(57) ABSTRACT

Disclosed embodiments include a protective headwear having a headband and an insulating drape and a method of manufacturing the same. Other embodiments may be described and claimed.

### FIELD

Embodiments of the present disclosure relate generally to the field of protective headwear.

### BACKGROUND

An example of a common hairstyling technique is to use a hair iron to apply concentrated heat in order to change the structure and look of hair. Hair irons could include curling irons, straightening irons, and crimping irons. Heating elements within these hair irons may heat to temperatures in excess of 400 degrees Fahrenheit. The routine use of such hair irons in close proximity to exposed skin on the scalp, neck, ears and forehead may result in painful injuries.

Another example of a hairstyling technique is hair coloring. In some cases, color is intended to be applied to some parts of the hair and not other parts. The inability to protect parts of the hair from coloring may result in undesired visual consequences. Other hairstyling techniques may involve chemicals that are harmful to hair and/or exposed skin.

### BRIEF DESCRIPTION OF THE DRAWINGS

Embodiments are illustrated by way of example and not by way of limitation in the figures of the accompanying drawings, in which like references indicate similar elements and in which:

FIG. 1a illustrates a perspective view of a protective headwear,

FIG. 1b illustrates the protective headwear of FIG. 1a positioned on a user's head,

FIG. 2 illustrates an insulating drape of the protective headwear of FIG. 1a,

FIG. 3 illustrates a cross-sectional view of another protective headwear,

FIG. 4 illustrates a side view of another protective headwear,

FIG. 5 illustrates a side view of another protective headwear,

FIG. 6 illustrates a side view of another protective headwear,

FIG. 7a illustrates a side view of another protective headwear in a first position,

FIG. 7b illustrates a side view of the protective headwear of FIG. 7a in a second position,

FIG. 8 illustrates a perspective view of still another protective headwear, and

FIG. 9 illustrates a flowchart of a manufacturing process of a protective headwear, all in accordance with at least some embodiments.

### DETAILED DESCRIPTION

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific devices and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

The phrase “in one embodiment” is used repeatedly. The phrase generally does not refer to the same embodiment; however, it may. The terms “comprising,” “having,” and “including” are synonymous, unless the context dictates otherwise.

In providing some clarifying context to language that may be used in connection with various embodiments, the phrases “NB” and “A and/or B” mean (A), (B), or (A and B); and the phrase “A, B, and/or C” means (A), (B), (C), (A and B), (A and C), (B and C), or (A, B and C).

The term “coupled with,” along with its derivatives, may be used herein. “Coupled” may mean one or more of the following. “Coupled” may mean that two or more elements are in direct physical contact. However, “coupled” may also mean that two or more elements indirectly contact each other, but yet still cooperate or interact with each other, and may mean that one or more other elements are coupled or connected between the elements that are said to be coupled to each other.

Embodiments of the present disclosure describe various protective headwear (hereinafter also referred to as “headwear”) and associated manufacturing processes. The headwear may be worn by a user during application of heat, e.g., from a hair iron, to the user's hair. Wearing the headwear in such circumstances may protect the user from injury while still providing unimpeded access to the user's hair.

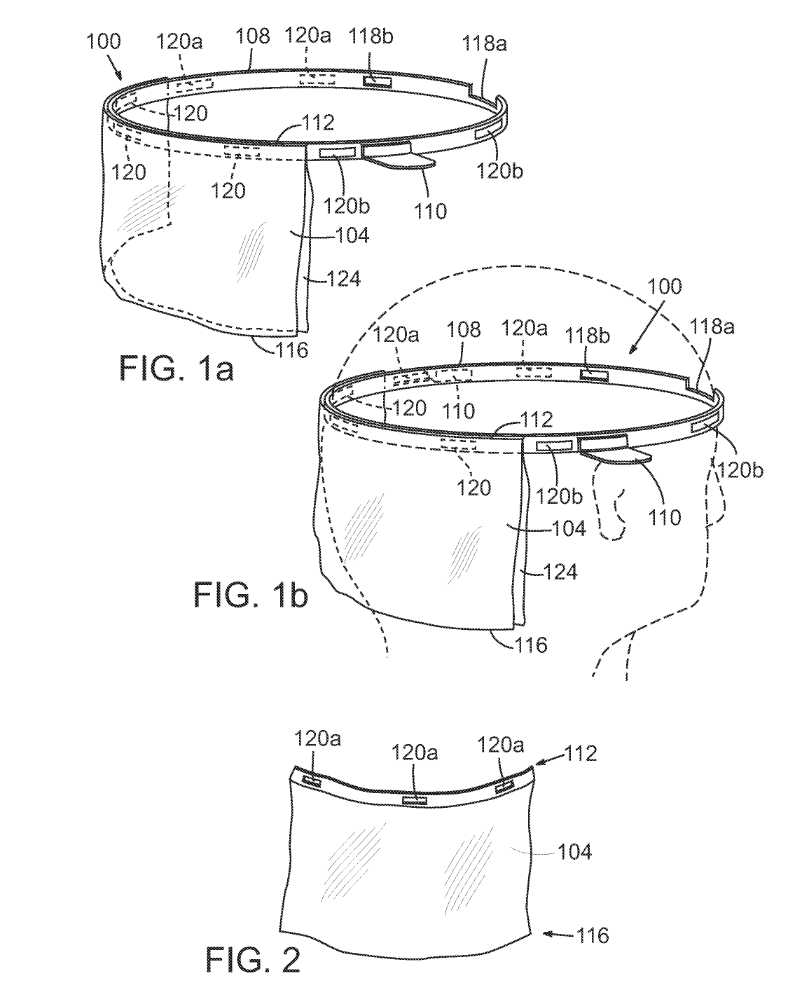

FIG. 1a illustrates a headwear 100 in accordance with some embodiments. The headwear 100 may be an article of manufacture that includes an insulating drape 104 and a headband 108. FIG. 2 shows the insulating drape 104 separately from the headband 108 in accordance with some embodiments. The insulating drape 104 may include a first border 112 and a second border 116. The second border 116 may be located opposite from the first border 112, i.e., the second border 116 may be distally located with respect to the first border 112. The first border 112 may be coupled with the headband 108, and the second border 116 may be unencumbered. While FIG. 1 shows one insulating drape, i.e., insulating drape 104, coupled with the headband 108, other embodiments may have more than one insulating drape coupled with the headband 108.

The headband 108 may be an elastic headband made of a stretchable fabric, e.g., a fabric that includes an elastic polymer to provide the fabric with elastic properties. The headband 108 may be made of materials such as, but not limited to, fleece, polyester, cotton, and terry cloth. The headband 108 shown in FIG. 1 is a continuous-loop headband.

The headband 108 may be configured to be positioned around a user's head with a user's hair exposed through an exposure aperture defined by the headband, as shown in FIG. 1a. In such a position, the insulating drape 104 may fall over an area of the user's head, hair, scalp, ears, forehead, and/or neck. In addition or as an alternative, headband 108 may include one or more openings, for example, one or more slots 118a and/or one or more holes 118b, as shown in FIG. 1a, and the user may pull hair over or through such openings. With the headwear 100 in place, the user may proceed to use a hair iron on exposed hair with the insulating drape 104 and/or headband 108 protecting the underlying skin from injury. A user may also proceed with coloring a certain part of hair, with the insulating drape 104 and/or headband 108 protecting other parts of hair from coloring. A user may also proceed with hairstyling techniques that involve chemicals, with the insulating drape 104 and/or headband 108 protecting the user's hair and/or skin from such chemicals.

As shown in FIG. 1a, the insulating drape 104 is only coupled with a section of the headband 108, the section being less than an entire perimeter of the headband 108. This allows a user to protect a particular area with the insulating drape 104 without having the insulating drape 104 impeding visibility or access to other areas. While FIG. 1b illustrates the headwear 100 positioned such that the insulating drape 104 is protecting a neck area of the user, the insulating drape 104 may be repositioned to protect other areas of the user's head, hair, scalp, and/or neck, e.g., over the user's ears, forehead, or face. Repositioning may be accomplished by rotating the headwear 100 around the user's head. In some positions, the elasticity of the headband 108 and/or the weight of the insulating drape 104 may be used to fold over, and hold down, a user's ear or ears to provide the user with access to hair that is immediately adjacent to the user's ears. Alternatively or in addition, the headband 108 and/or the insulating drape 104 may include an appendage 110 shown on headband 108 in FIG. 1a, for example, a piece of plastic or other material suitable for this purpose, that may be used to fold over, and hold down, a user's ear or ears.

The insulating drape 104 may be coupled with the headband 108 by way of fasteners 120. The fasteners 120 may be configured to permanently or removably couple the insulating drape 104 with the headband 108. A permanent coupling arrangement, i.e., a coupling arrangement that does not accommodate routine separation of the insulating drape 104 from the headband 108, may be accomplished by using fasteners 120 such as stitching or adhesives. A removably coupling arrangement, i.e., a coupling arrangement that accommodates routine separation of the insulating drape 104 from the headband 108, may be accomplished by using fasteners 120 such as hook-and-loop fasteners, zip fasteners, snap fasteners, button fasteners, hood fasteners, and magnetic fasteners. A removable coupling arrangement also may be accomplished by tucking an insulating drape 104 into a headband 108.

In embodiments in which the fasteners 120 are configured to removably couple the insulating drape 104 with the headband 108, the fasteners 120 may have first fasteners 120a disposed on the insulating drape 104 and second fasteners 120b disposed on the headband 108. The first fasteners 120a disposed on the insulating drape 104 may be seen with reference to FIG. 2. The first fasteners 120a and second fasteners 120b may be complementary fasteners configured to couple with one another. In these embodiments, the repositioning of the insulating drape 104 may be accomplished by decoupling the insulating drape 104 from the headband 108 and re-coupling in another position. Thus, the headband 108 may include second fasteners 120b positioned around a perimeter of its continuous loop to facilitate the coupling of the insulating drape 104 in a variety of positions around the headband 108.

In some embodiments, the headband 108 may include a pair of fasteners, e.g., first and second fasteners 120a and 120b, on an interior portion. These may be used to couple with one another to change an effective circumference of the headband 108. This may be useful, e.g., when the headband 108 is positioned around a user's neck and the insulating drape is used to protect the back of the user's neck.

The insulating drape 104 may include one or more materials that provide heat-resistance and insulation. The insulating drape 104 may be flexible or rigid. The insulating drape 104 may be a multilayered drape with one or more layers selected for their heat-resistant properties and one or more other layers selected for their insulating properties. In other embodiments, the insulating drape 104 may include one or more layers having both heat-resistant and insulating properties. Materials that may be used for heat-resistant properties may include synthetic, semisynthetic, and/or natural fibers that resist burning and/or melting at relatively high temperatures. These fibers may include aromatic polyamide (“aramid”) fibers (e.g., meta-aramid, para-aramid, and/or copolyamide), modacrylic fibers, rayon fibers, polyester fibers, etc. In some embodiments, heat-resistant coatings may be additionally/alternatively applied to the fibers.

The headwear 100 may also include an interior drape 124. The interior drape 124 may be coupled with the insulating drape 104 and/or the headband 108 in a manner to underlay the insulating drape 104. The dimensions of interior drape 124 may be substantially similar to dimensions of the insulating drape 104. Alternatively, the dimensions of interior drape 124 may be different than dimensions of the insulating drape 104. By underlaying the insulating drape 104, the interior drape 124 may provide additional comfort and/or insulation to the user. The interior drape 124 may be a cloth drape that includes any type of material such as, but not limited to, polyester, acrylic, cotton, wool, silk, etc.

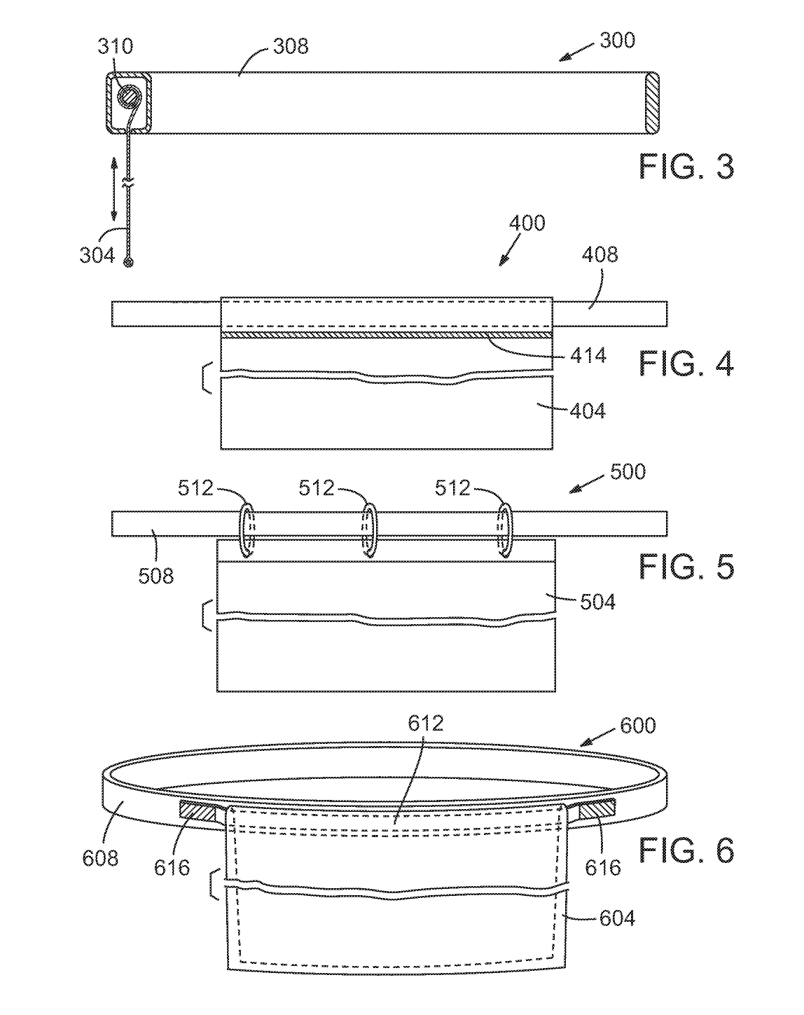

FIG. 3 shows a cross-sectional view of headwear 300 in accordance with some embodiments. In this embodiment, an insulating drape 304 may be coupled with a headband 308 by being integrated into the headband 308. The insulating drape 304 may be coupled with a spring roller 310. The spring roller 310 may be configured to alternately wind and unwind the insulating drape 304. The insulating drape 304 may be pulled down by the user as needed. This may provide the user with the flexibility of setting the insulating drape 304 at various lengths. A user may partially or fully retract the insulating drape 304 by pulling the insulating drape 304 down and then releasing the tension on the insulating drape 304.

FIG. 4 shows a side view of headwear 400 in accordance with some embodiments. The headwear 400 may include an insulating drape 404 coupled with a headband 408. In this embodiment, a top edge of the insulating drape 404 may be folded over and coupled with section 414 of the insulating drape 404 thereby creating a loop through which the headband 408 may pass. The top edge of the insulating drape 404 may be permanently or removably coupled with section 414. The loop may be continuous, i.e., extending along the entire width of the insulating drape 404, as shown. In another embodiment, the insulating drape 404 may form one or more segmented loops. In some embodiments, a user may slide the insulating drape 404 around the headband 408 from one position to another position as desired.

FIG. 5 shows a side view of headwear 500 in accordance with some embodiments. The headwear 500 may include an insulating drape 504 coupled with a headband 508 by using ring fasteners 512. In this embodiment, the ring fasteners 512 may be placed around the headband 508 and through holes in the insulating drape 504. Similar to headwear 400, headwear 500 provides the user with the ability to slide the insulating drape 504 around the headband 508 to reposition as desired.

FIG. 6 shows a side view of headwear 600 in accordance with some embodiments. The headwear 600 may include an insulating drape 604 coupled with a headband 608 by fastener 612. The fastener 612 may be removably or permanently coupled with the headband 608 at sections 616. The insulating drape 604 may be pulled through a space between the fastener 612 and the headband 608 and draped over the fastener 612 as shown. In some embodiments additional fasteners, similar to fastener 612, may be placed around the perimeter of headband 608 allowing flexible coupling arrangements.

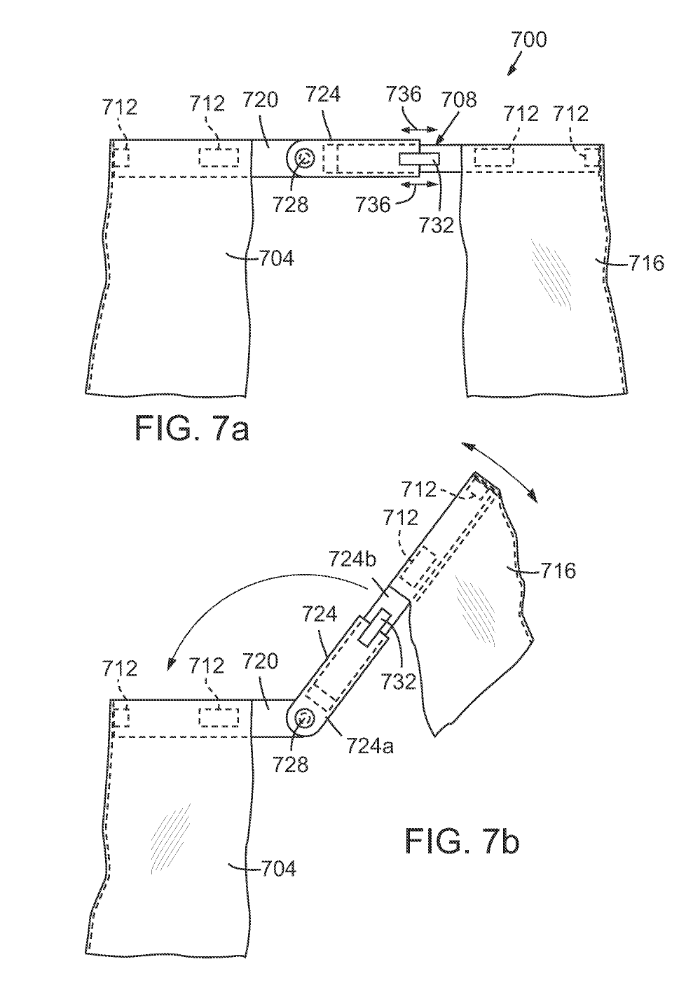

FIGS. 7a and 7b show two side views of a headwear 700 in accordance with some embodiments. Similar to the headwear 100, the headwear 700 may include an insulating drape 704 coupled with a headband 708 by fasteners 712. However, the headwear 700 may include another insulating drape 716, and the headband 708 may be a rigid headband that includes a first portion 720 coupled with a second portion 724 at hinges 728 (only one shown). The headband 708 may be made of a plastic or a metal material.

The first portion 720 may be rotated, with respect to the second portion 724, about the hinges 728. This may provide a user with additional flexibility to expose a portion of their hair through exposure apertures of various sizes with protection afforded by both insulating drape 704 and insulating drape 716.

In some embodiments, the headwear 700 may include an adjustment mechanism 732 to adjust the circumference of the headband 708 to accommodate different head sizes. In these embodiments, the second portion 724 may include a first section 724a and a second section 724b. The adjustment mechanism 732 may facilitate the adjustment of the position of the first section 724a relative to the second section 724b (as indicated by arrows 736) to increase and decrease the circumference of the headband 708. In various embodiments, the adjustment mechanism 732 may include fasteners or other devices that are used to engage the first section 724a with the second section 724b in an adjustable manner.

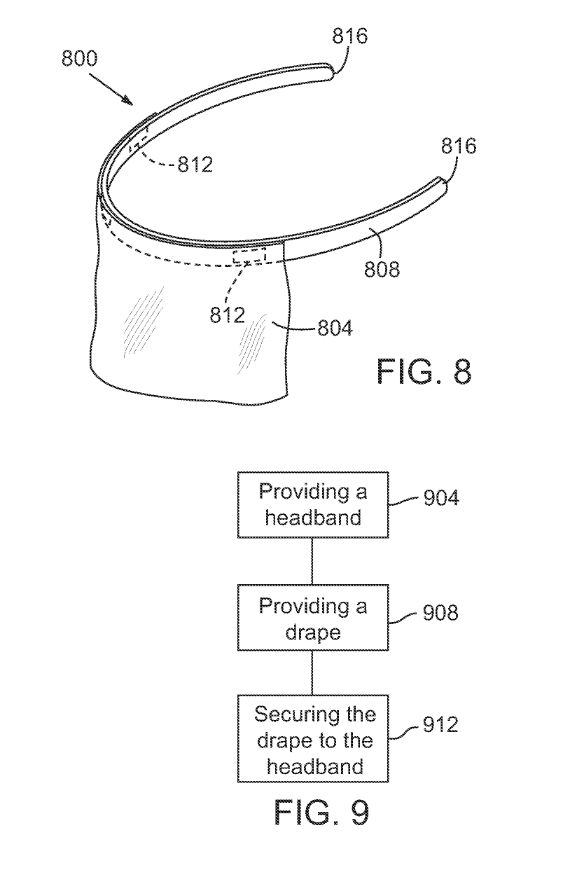

FIG. 8 illustrates a headwear 800 in accordance with some embodiments. Headwear 800, similar to headwear 100, includes an insulating drape 804 coupled with a headband 808 by fasteners 812. However, headband 808 may be a horseshoe-shaped headband, rather than a continuous-loop headband as described above with respect to headband 108.

The headband 808 may be a hard plastic or a metal headband. The headband 808 may be held in place on a user's head by a restoring force that presses ends 816 of the headband 808 together when they are stretched from an equilibrium state and placed around a user's head.

FIG. 9 illustrates a method of manufacturing a headwear in accordance with some embodiments. The method may include, at block 904 (“Providing a headband”), providing a headband such as headband 108, 308, 408, 508, 608, 708, or 808. The method may also include, at block 908 (“Providing a drape”), providing a drape, such as an insulating drape 104, 304, 404, 504, 604, 704, 716, or 804, with a first border and a second border, the second border being distally located from the first border. The method may also include, at block 912 (“Securing the drape to the headband”), securing the drape to the headband. This may include, securing a first fastener to the headband and securing a second fastener to the drape to facilitate a coupling of the drape with the headband. Securing the drape to the headband may include other variations with respect to other embodiments. For example, securing the drape to the headband may include securing the first border within the headband.

Unless otherwise stated, features of various headwear described in this disclosure may be substantially interchangeable. For example, while all of the features of headwear 100 are not shown on headwear of other embodiments, they may be selectively incorporated on the headwear of the other embodiments just the same.

Although the present disclosure has been described in terms of the above-illustrated embodiments, it will be appreciated by those of ordinary skill in the art that a wide variety of alternate and/or equivalent implementations calculated to achieve the same purposes may be substituted for the specific embodiments shown and described without departing from the scope of the present disclosure. Those with skill in the art will readily appreciate that the teachings of the present disclosure may be implemented in a wide variety of embodiments. This description is intended to be regarded as illustrative instead of restrictive.

What is claimed is:

1. An article of manufacture comprising:
a headband configured to be positioned around a user's head, with the user's hair exposed above the headband; and
a drape having a first border and a second border, the first border coupled with the headband, and the second border being unencumbered and distally located with respect to the first border.

2. The article of manufacture of claim 1, wherein the headband comprises an elastic headband.

3. The article of manufacture of claim 1, wherein the drape comprises a fastener configured to removably couple the drape with the headband.

4. The article of manufacture of claim 3, wherein the fastener comprises a hook-and-loop fastener, a zip fastener, a snap fastener, a button fastener, a hook fastener, a ring fastener, or a magnetic fastener.

5. The article of manufacture of claim 3, wherein the fastener is a first fastener and the headband comprises a second fastener configured to complement the first fastener, to allow the drape to be removably coupled with the headband.

6. The article of manufacture of claim 5, wherein the headband comprises a plurality of second fasteners to allow the drape to be removably coupled with the headband in a plurality of positions around the headband.

7. The article of manufacture of claim 1, wherein the headband is a rigid headband.

8. The article of manufacture of claim 7, wherein the headband includes a first portion and a second portion, the first portion coupled with the second portion with a first and second hinge that allows the second portion to rotate with respect to the first portion.

9. The article of manufacture of claim 8, wherein the drape is a first drape coupled with the first portion and the article further comprises a second drape coupled with the second portion.

10. The article of manufacture of claim 1, wherein the drape comprises a continuous loop at the first border.

11. The article of manufacture of claim 1, wherein the drape comprises one or more segmented loops at the first border.

12. The article of manufacture of claim 7, further comprising:
an adjustable mechanism configured to adjust a circumference of the headband.

13. The article of manufacture of claim 1, wherein the headband is a continuous-loop headband.

14. The article of manufacture of claim 1, wherein the headband is a horseshoe-shaped headband.

15. The article of manufacture of claim 1, wherein the headband comprises a pair of fasteners configured to be coupled to one another to change an effective circumference of the headband.

16. The article of manufacture of claim 1, wherein the headband includes one or more openings.

17. The article of manufacture of claim 1, further comprising:
an appendage coupled with the headband.

18. The article of manufacture of claim 1, wherein the drape is coupled with a section of the headband, the section being less than an entire perimeter of the headband.

19. The article of manufacture of claim 1, wherein the drape is a first drape that comprises a heat-resistant material and the article further comprises a second drape that is coupled with the first drape and/or the headband in a manner to underlay the first drape.

20. The article of manufacture of claim 19, wherein the second drape comprises a cloth drape.

21. An article of manufacture comprising:
a headband configured to be positioned around a user's head, with the user's hair exposed above the headband; and
a drape having a first border and a second border, the first border coupled inside the headband, and the second border being unencumbered and distally located with respect to the first border when the drape is pulled from within the headband.

22. The article of manufacture of claim 21, further comprising:
a spring roller coupled with the first border of the drape and disposed within the headband, the spring roller configured to alternately wind and unwind the drape.

23. A method comprising:
providing a headband;
providing a drape with a first border and a second border, the second border being distally located from the first border; and
securing the drape to the headband.

24. The method of claim 23, wherein said securing the drape comprises:
securing a first fastener to the headband; and
securing a second fastener to the drape at the first border to facilitate a coupling of the drape with the headband.

25. The method of claim 24, wherein said securing the drape comprises securing the first border within the headband.
